(19) United States
(12) Patent Application Publication
(10) Pub. No.: US 2012/0132008 A1
(43) Pub. Date: May 31, 2012

(54) FIBER OPTIC LOAD MEASUREMENT DEVICE

(76) Inventors: Donald R. Way, Scottsdale, AZ (US); Michael McNeilly, Gilbert, AZ (US)

(21) Appl. No.: 13/276,880

(22) Filed: Oct. 19, 2011

Related U.S. Application Data
(60) Provisional application No. 61/394,468, filed on Oct. 19, 2010.

(51) Int. Cl. G01L 1/24

(52) U.S. Cl. 73/800

(57) ABSTRACT

A measurement device may include a loadable member that supports a load and measures the force created in the loadable member by the load. The loadable member may have an aperture and an optical fiber located within the aperture. The optical fiber may include one or more fiber Bragg grating (FBG) sensors.

This application claims priority to U.S. Ser. No. 61/394,468, entitled FIBER OPTIC LOAD CELL, filed Oct. 19, 2010, which is incorporated herein by reference.

### BACKGROUND OF THE INVENTION

A. Field of Invention

This invention relates generally to load cells or load/force measurement devices and more particularly to load cells or load/force measurement devices which use Fiber Bragg Grating (FBG) sensor.

B. Description of the Related Art

It is well known in the art to use a load measurement device, sometimes called a load cell, to measure tensile or compressive loads.

However, what is needed is a load measurement device which can determine tension or compression loads using one or more Fiber Bragg Grating (FBG) sensors.

### SUMMARY OF THE INVENTION

According to one embodiment of this invention, a load measurement device may include a loadable member that supports a load and measures the force created in the loadable member by the load. The loadable member may have an aperture extending through the length of the loadable member. The load measurement device may also include a first optical fiber located within the aperture, wherein the first optical fiber includes at least one FBG sensor.

According to another embodiment of this invention, a load measurement device may include: a loadable member having a neutral axis and an aperture that extends at least partially along the neutral axis; a fiber optic cable having a first end that is at least partially positioned within the aperture and a second end that extends outside of the aperture; a first FBG sensor that: (1) is positioned within the fiber optic cable; (2) is positioned within the aperture along the neutral axis; and, (3) measures strain; a second FBG sensor that: (1) is positioned within the fiber optic cable; (2) is positioned within the aperture along the neutral axis; (3) compensates for temperature; and, (4) is operatively connected to the first FBG sensor; and, a FBG sensor interrogator system operatively connected to the second end of the fiber optic cable and used to analyze the first and second FBG sensors to determine a load applied to the loadable member.

According to yet another embodiment of this invention, a method of using a load measurement device may include the steps of: (A) providing a loadable member having a neutral axis and an aperture that extends at least partially along the neutral axis; (B) providing a fiber optic cable having a first end that is at least partially positioned within the aperture and a second end that extends outside of the aperture; (C) providing a first FBG sensor that: (1) is positioned within the fiber optic cable; (2) is positioned within the aperture along the neutral axis; and, (3) measures strain; (D) providing a second FBG sensor that: (1) is positioned within the fiber optic cable; (2) is positioned within the aperture along the neutral axis; (3) compensates for temperature; and, (4) is operatively connected to the first FBG sensor; (E) providing a FBG sensor interrogator system operatively connected to the second end of the fiber optic cable; (F) applying a load to the loadable member; and, (G) using the FBG sensor interrogator system to analyze the first and second FBG sensors to determine the load applied to the loadable member.

One advantage of this invention is the reduced size and mass of the load measurement device. A typical load cell used in the industry to measure 60,000 pounds load would be 6 to 8 inches in diameter and 6 to 8 inches long. The weight of the load measurement device could be as much as 10 pounds. However, a fiber optic load measurement device according to this invention capable of the same load capabilities could be as small as ¾ inch in diameter and as short as 1 inch long. For measurements above 120,000 pounds, the conventional load measurement device size becomes very large and extremely difficult to handle, whereas the fiber optic load measurement device of this invention could weigh only a few pounds.

Another advantage of this invention is the fiber optic load cell load measurement device could be utilized in very restricted locations and environments due its reduced size and an almost unlimited geometry.

Another advantage of this invention is the ability to measure extremely fast transient load changes without adding inertial mass to the test specimen, especially on very small components, due to the reduced size and weight of the fiber optic load measurement device.

Yet another advantage of this invention is that the fiber optic load measurement device is immune to electromagnetic fields (EMF) making this load measurement device an ideal solution for gathering data in previously impossible conditions and at long distances from the data-gathering instrumentation.

Still another advantage of the invention is its resistance to contaminants relative to conventional electrically based load measurement devices. Conventional load measurement device technology precludes its use under water or in caustic environments unless it is encapsulated in a larger cumbersome enclosure.

Another advantage of the invention is the ability to safely use it in fire-hazard and explosion-hazard environments. The low-power laser light used is not an ignition source.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a cross-section view of a fiber optic load measurement device according to one embodiment.

FIG. 2 is a close-up view of the Detail C shown in FIG. 1.

FIG. 3 is a cross-section view of a fiber optic load measurement device according to another embodiment.

### DETAILED DESCRIPTION OF THE INVENTION

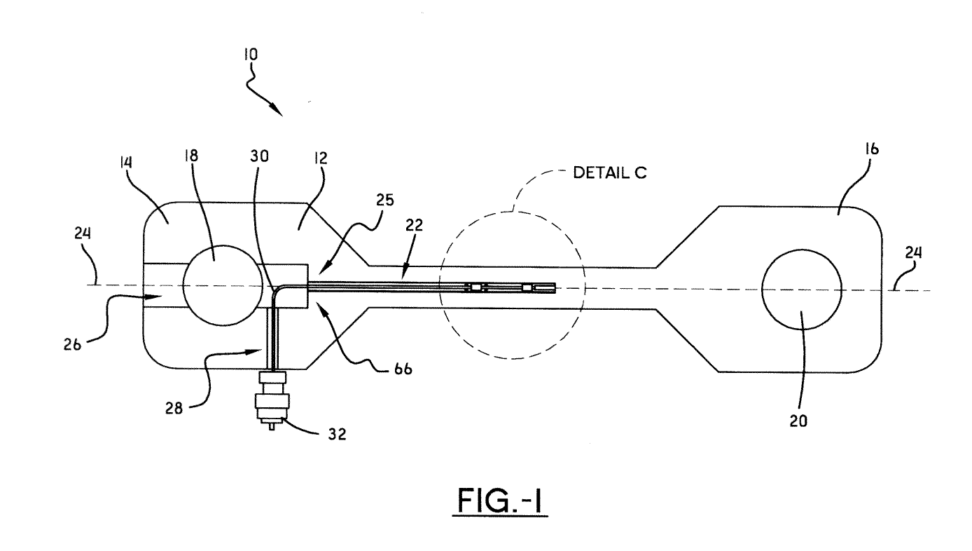

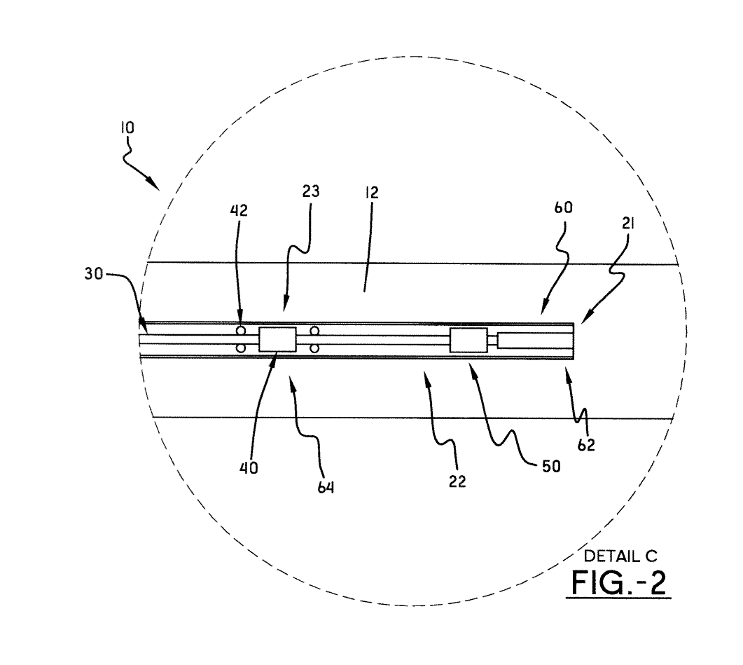

Referring now to the drawings wherein the showings are for purposes of illustrating embodiments of the invention only and not for purposes of limiting the same, and wherein like reference numerals are understood to refer to like components, FIGS. 1 and 2 shows a fiber optic load measurement device 10, according to one embodiment of this invention. The load measurement device 10 may include one or more loadable members 12, at least one optical fiber (one fiber optic cable 30 shown), at least one Fiber Bragg Grating (FBG) sensor (two shown, strain measuring Fiber Bragg Grating (FBG) sensor 40 and temperature compensating FBG sensor 50), and a tube 60. The loadable member 12 supports a load and measures the force created in the loadable member 12 by the load. The loadable member 12 may be formed of any material chosen with ordinary skill in the art. The loadable member 12 may include ends 14, 16 with openings 18, 20 for attaching the load measurement device 10 in any manner chosen with ordinary skill in the art. The loadable member 12 may include an aperture 22 extending through at least a portion of the length of the loadable member 12 along the neutral axis 24 of the loadable member 12. In one embodiment, the aperture extends through an entire length of the loadable member 12. The aperture 22 is sized to receive the tube 60 with the FBG sensors 40, 50 or the FBG sensors 40, 50 without the tube 60. The placement of the FBG sensors 40, 50 on the neutral axis of the loadable member 12 reduces the influence of bending forces, which can cause errors in the output of the FBG sensor. The FBG sensors 40, 50 may be positioned, for the embodiment shown, with the FBG sensor 50 positioned distally of the FBG sensor 40.

The loadable member 12 may include aperture 26 for installing the tube 60 with the FBG sensors 40, 50, or the FBG sensors without the tube, into the aperture 22 of loadable member 12. The loadable member 12 may include aperture 28, which can act as a conduit or duct for the fiber optic cable 30. Optical connectors 32 may be used to secure the fiber optic cable 30. In one embodiment, an optical connector is provided at each end of the fiber optic cable 30. The fiber optic cable 30 may include an optical connector 32, which may be any type of fiber optic cable connector chosen with ordinary skill in the art. The strain measuring FBG 40 and the temperature compensating FBG sensor 50 may be any type of Fiber Bragg Grating chosen with ordinary skill in the art. The FBG sensors 40, 50 may also include any gating structure chosen with ordinary skill in the art. The FBG sensors 40, 50 can be connected to a Fiber Bragg Grating (FBG) interrogator system, as is well known in the art. The tube 60 may be hollow and may be formed of any material chosen with ordinary skill in the art. The tube 60 may have a closed end 62 and open end 66, or two open ends 62, 66.

With continuing reference to FIGS. 1 and 2, the FBG sensors 40, 50 may be attached to the loadable member 12 by at least two different methods. In the first embodiment, the FBG sensors 40, 50 are first installed into the tube 60, and then the tube 60 is installed in the loadable member 12. In this embodiment, the FBG sensor 50 may be positioned inside the tube 60 near one end 62. The FBG sensor 50 may be operatively connected to the FBG sensor 40. Each end of the FBG 40 may be attached to a mid-portion 64 of the tube 60 by glue, epoxy, adhesive or any other attachment means 42 chosen with ordinary skill in the art. The glue, epoxy, or adhesive may form a seal between the FBG sensor 40 and the rest of the tube 60. The FBG sensor 40 is precisely pre-tensioned when attached to the tube 60. The FBG sensor 40 may be operatively connected to the fiber optic cable 30, which extends from FBG sensor 40 through the second end 66 of the tube 60. Glue, epoxy, or any other adhesive chosen with ordinary skill in the art may be located at one end 62 or 66, or at both ends 62, 66 of the tube 60, or throughout substantially the entire tube 60. When the glue, epoxy, or other adhesive is located at end 66 or both ends 62, 66, then the remaining space in the tube 60 may be filled with air, gas, fluid, liquid, gel, or solid material. The tube 60 may be inserted into the aperture 22 of loadable member 12 and attached with glue, epoxy, or any other adhesive chosen with ordinary skill in the art. The fiber optic cable 30 may extend through the aperture 28 to the fiber optic cable connector 32 when the tube 60 is installed in the loadable member 12.

With continuing reference to FIGS. 1 and 2, the FBG sensors 40, 50 may be attached to the loadable member 12 without using the tube 60. In this second embodiment, the FBG sensors 40, 50 are installed directly into the loadable member 12. The FBG 50 may be positioned near one end 21 of the aperture 22. The FBG sensor 50 may be operatively connected to the FBG sensor 40. Each end of the FBG sensor 40 may be attached to a mid-portion 23 of the aperture 22 by glue, epoxy, adhesive or any other attachment means 42 chosen with ordinary skill in the art. The glue, epoxy, or adhesive may form a seal between the FBG sensor 40 and the rest of the aperture 22. The FBG sensor 40 is precisely pre-tensioned when attached to the aperture 22. The FBG sensor 40 may be operatively connected to the fiber optic cable 30, which extends from FBG sensor 40 through the second end 25 of the aperture 22. The fiber optic cable 30 may then extend through the aperture 28 to a fiber optic cable connector 32. Glue, epoxy, or any other adhesive chosen with ordinary skill in the art may be located at one end 21 or 25, or at both ends 21, 25 of the aperture 22, or throughout substantially the entire aperture 22. When the glue, epoxy, or other adhesive is located at one end 25 or at both ends 21, 25, then the remaining space in the tube 60 may be filled with air, gas, fluid, liquid, gel, or solid material.

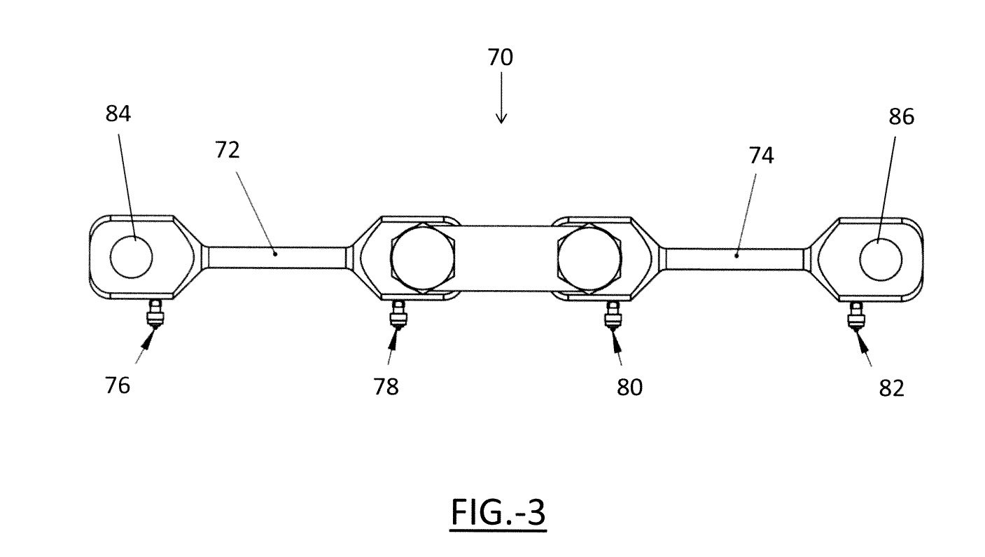

FIG. 3 shows a fiber optic load measurement device 70, according to another embodiment of this invention. The load measurement device 70 includes first and second loadable members 72, 74. The loadable members 72, 74 may support independent loads or, in another embodiment, may together support the same load. The loadable member 12 may be formed of any material chosen with ordinary skill in the art. The loadable members 72, 74 may include openings 84, 86 for attaching the load measurement device 70 in any manner chosen with ordinary skill in the art. Each loadable member 72, 74 may have an internal aperture similar to the aperture 22 noted above. Each loadable member 72, 74 may receive at least one optical fiber and at least one FBG sensor positioned within the aperture. As with the embodiments noted above, two FBG sensors may be used. In one specific embodiment, one FBG sensor may be a strain measuring sensor and another FBG sensor may be temperature compensating similar to FBG sensors 40 and 50 noted above. The FBG sensors may be positioned in any manner chosen with the sound judgment of a person of skill in the art. In another embodiment, a tube (similar to tube 60 discussed above) may be used with the apertures in the loadable members 72, 74 to receive the at least one optical fiber and the at least one FBG sensor. One or more optical connectors 76, 78 may be used with the first loadable member 72 to permit connection to the at least one optical fiber positioned within the corresponding aperture. Similarly, one or more optical connectors 80, 82 may be used with the second loadable member 74 to permit connection to the at least one optical fiber positioned within the corresponding aperture. The FBG sensors within the first and second loadable members 72, 74 can be connected to a FBG interrogator system, as is well known in the art.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A load measurement device comprising:
a loadable member that supports a load and measures the force created in the loadable member by the load, the loadable member having an aperture extending through at least a portion of the length of the loadable member; and,
a first optical fiber located within the aperture, wherein the first optical fiber includes at least one FBG sensor.

2. The measurement device of claim 1 wherein the first end of the first optical fiber is secured near the first end of the aperture and the second end of the first optical fiber is secured neat the second end of the aperture.

3. The measurement device of claim 1 further comprising:
a first optical connector attached to the first end of the first optical fiber, wherein the first optical connector secures the first end of the first optical fiber;
a second optical connector attached to the second end of the first optical fiber, wherein the second optical connector secures the second end of the first optical fiber; and,
wherein at least a portion of the first optical connector is located within the aperture near a first end of the loadable member and at least a portion the second optical connector is located within the aperture near a second end of the loadable member.

4. The measurement device of claim 1 wherein the first optical fiber is secured within the aperture in a pre-tensioned condition.

5. The measurement device of claim 1 wherein the aperture extends through an entire length of the loadable member, and wherein the first end of the first optical fiber is secured near a first end of the loadable member and the second end of the first optical fiber is secured near a second end of the loadable member.

6. The measurement device of claim 1 further comprising:
a second loadable member, the second loadable member having an aperture extending through a length of the second loadable member; and
a second optical fiber located within the aperture, the second optical fiber including at least one FBG sensor;
wherein at least a portion of the second optical fiber is secured within the aperture;
wherein a first end of the second optical fiber can be connected to an associated third optical connector and a second end of the second optical fiber can be connected to an associated fourth optical connector; and,
wherein the first optical fiber is operatively connected to the second optical fiber.

7. The measurement device of claim 1 wherein:
the first end of the first optical fiber is secured to a first end of the aperture and the second end of the first optical fiber is secured to a second end of the aperture, and,
wherein the aperture is substantially filled with one of a gas, fluid, and gel.

8. A load measurement device comprising:
a loadable member having a neutral axis and an aperture that extends at least partially along the neutral axis;
a fiber optic cable having a first end that is at least partially positioned within the aperture and a second end that extends outside of the aperture;
a first FBG sensor that: (1) is positioned within the fiber optic cable; (2) is positioned within the aperture along the neutral axis; and, (3) measures strain;
a second FBG sensor that: (1) is positioned within the fiber optic cable; (2) is positioned within the aperture along the neutral axis; (3) compensates for temperature; and, (4) is operatively connected to the first FBG sensor; and,
a FBG sensor interrogator system operatively connected to the second end of the fiber optic cable and used to analyze the first and second FBG sensors to determine a load applied to the loadable member.

9. The load measurement device of claim 8 wherein the second FBG sensor is positioned distally of the first FBG sensor.

10. The load measurement device of claim 8 wherein the first FBG sensor is pre-tensioned.

11. The load measurement device of claim 8 wherein the first and second FBG sensors are attached to the loadable member within the aperture using at least one of glue, epoxy, and adhesive.

12. The load measurement device of claim 8 further comprising:
a tube that is at least partially positioned within the aperture;
wherein the first end of the fiber optic cable is at least partially positioned within the tube;
the first FBG sensor is positioned within the tube along the neutral axis; and,
the second FBG sensor is positioned within the tube along the neutral axis.

13. The load measurement device of claim 12 wherein:
the second FBG sensor is positioned distally of the first FBG sensor; and,
the first FBG sensor is attached to the tube using at least one of glue, epoxy, and adhesive.

14. The load measurement device of claim 12 wherein the remaining space in the tube is filled with one of a liquid, a gel and a solid material.

15. The load measurement device of claim 8 further comprising:
a connector attached to the second end of the fiber optic cable juaxtaposed to an outer surface of the loadable member.

16. A method of using a load measurement device comprising the steps of:
(A) providing a loadable member having a neutral axis and an aperture that extends at least partially along the neutral axis;
(B) providing a fiber optic cable having a first end that is at least partially positioned within the aperture and a second end that extends outside of the aperture;
(C) providing a first FBG sensor that: (1) is positioned within the fiber optic cable; (2) is positioned within the aperture along the neutral axis; and, (3) measures strain;
(D) providing a second FBG sensor that: (1) is positioned within the fiber optic cable; (2) is positioned within the aperture along the neutral axis; (3) compensates for temperature; and, (4) is operatively connected to the first FBG sensor;
(E) providing a FBG sensor interrogator system operatively connected to the second end of the fiber optic cable;
(F) applying a load to the loadable member; and,
(G) using the FBG sensor interrogator system to analyze the first and second FBG sensors to determine the load applied to the loadable member.

17. The method of claim 16 wherein prior to step (F) the method comprises the steps of:
(H) providing a tube;
(I) installing the first end of the fiber cable and the first and second FBG sensors into the tube; and,
(J) installing the tube into the aperture along the neutral axis after step (I).

18. The method of claim 17 wherein step (I) comprises the steps of:
positioning the second FBG sensor distally of the first FBG sensor; and,
attaching the first FBG SENSOR to the tube using at least one of glue, epoxy, and adhesive.

19. The method of claim 17 wherein prior to step (J) the method comprises the step of:
filling the remaining space in the tube with one of a liquid, a gel and a solid material.

20. The method of claim 16 wherein prior to step (F) the method comprises the step of:
pre-tensioning the first FBG sensor.
